(19) United States
(12) Patent Application Publication
(10) Pub. No.: US 2026/0186557 A1
(43) Pub. Date: Jul. 2, 2026

(54) DYNAMIC VOLTAGE MARGIN ADJUSTMENT BASED ON WORKLOAD CHARACTERISTICS

(71) Applicants: Advanced Micro Devices, Inc., Santa Clara, CA (US); ATI Technologies ULC, Markham (CA)

(72) Inventors: Ashish Jain, Austin, TX (US); Sriram Sundaram, Austin, TX (US); Samuel Naffziger, Fort Collins, CO (US); Jemima Khan, Markham (CA)

(73) Assignees: Advanced Micro Devices, Inc., Santa Clara, CA (US); ATI Technologies ULC, Markham (CA)

(21) Appl. No.: 19/007,218

(22) Filed: Dec. 31, 2024

(51) Int. Cl. G06F 1/3296; G06F 1/3206

(52) U.S. Cl. CPC G06F 1/3296; G06F 1/3206

(57) ABSTRACT

Systems, methods, and non-transitory computer-readable media for dynamic voltage margin adjustment are disclosed. In some aspects, a system includes a processor, a power supply monitor (PSM) configured to measure voltage levels of the processor, and a voltage control module. The voltage control module may monitor minimum voltage levels reported by the PSM, compare the minimum voltage levels to one or more thresholds, and dynamically adjust a voltage margin applied to the processor based on the comparison. The voltage margin adjustment may be performed in real-time and may account for different workload characteristics, potentially optimizing processor performance and power efficiency.

### BACKGROUND

Modern computing systems, particularly those used in high-performance applications, often face challenges related to power consumption and performance optimization. These systems typically employ various voltage management techniques to balance power efficiency with computational capabilities. In some examples, processors and other integrated circuits operate within specific voltage ranges to ensure proper functionality and reliability.

Voltage fluctuations, commonly referred to as voltage droop, can occur during operation due to rapid changes in current demand. These fluctuations may vary significantly depending on the workload being executed. Some workloads, particularly those designed to stress test systems, can generate more substantial voltage droop compared to typical applications. To account for these variations, computing systems may implement voltage margining techniques.

In some implementations, a fixed voltage margin is applied across all workloads to ensure stability under worst-case scenarios. However, this approach may result in suboptimal performance for workloads that do not require such conservative voltage settings. As computing systems continue to evolve, there is an ongoing need for more sophisticated voltage management techniques that can adapt to the specific characteristics of different workloads.

### BRIEF DESCRIPTION OF THE FIGURES

The accompanying drawings illustrate a number of exemplary implementations and are a part of the specification. Together with the following description, these drawings demonstrate and explain various principles of the present disclosure.

FIG. 1 illustrates a block diagram of a computing system for dynamic voltage margin adjustment, according to aspects of the present disclosure.

FIG. 2 includes a voltage graph depicting voltage droop levels, thresholds, and margins, in accordance with example embodiments.

FIG. 3 illustrates a flowchart of a method for dynamic voltage margin adjustment, according to an embodiment.

FIG. 4 illustrates a flowchart of another method for dynamic voltage margin adjustment, according to aspects of the present disclosure.

Throughout the drawings, identical reference characters and descriptions indicate similar, but not necessarily identical, elements. While the examples described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to systems and methods for dynamically adjusting voltage margins based on workload characteristics in computing systems. As will be explained in greater detail below, by dynamically adjusting voltage margins based on workload characteristics, the various systems and methods described herein may be able to optimize processor performance and power efficiency. Upon monitoring minimum voltage levels reported by power supply monitors (PSMs) and comparing them to predefined thresholds, the systems and methods can apply different voltage margins tailored to the specific needs of various workload types. By adjusting voltage margins in this way, the systems and methods described herein may potentially improve performance for typical workloads that do not require conservative voltage settings, while still maintaining stability for more demanding applications. Additionally, this dynamic approach allows for immediate reversion to higher voltage margins when necessary, ensuring system reliability across a wide range of operating conditions. These systems and methods may potentially facilitate better utilization of processor capabilities, improved energy efficiency, and enhanced overall system performance compared to traditional fixed voltage margin approaches.

Modern computing systems face significant challenges in power management, particularly in balancing performance and energy efficiency. As processors become more complex and operate at higher frequencies, managing voltage levels becomes increasingly critical. Voltage margining is a technique used to ensure stable operation of processors by applying additional voltage above the minimum required level. This margin helps account for voltage fluctuations and prevents system failures due to insufficient voltage supply.

Traditionally, voltage margining has been implemented using a fixed approach, where a constant voltage margin is applied regardless of the workload being executed. While this method ensures stability, it may result in suboptimal performance and power efficiency for many typical workloads that do not require such a large margin.

Dynamic voltage margin adjustment offers a more sophisticated approach to power management. This technique allows the system to adapt the voltage margin based on real-time monitoring of the processor's voltage levels. By dynamically adjusting the margin, the system can optimize performance and power efficiency for typical workloads while still applying necessary margin for worst-case di/dt (current change over time) workloads.

The benefits of dynamic voltage margin adjustment over traditional fixed margin approaches may include improved performance by reducing the voltage margin for less demanding workloads, potentially allowing the processor to operate at higher frequencies; enhanced power efficiency through lower voltage margins for typical workloads, resulting in reduced power consumption; adaptive protection by applying higher margins when necessary for more demanding workloads to maintain stability and reliability; and flexibility to respond to varying workload characteristics in real-time, providing a more nuanced approach to power management.

By implementing dynamic voltage margin adjustment, computing systems may achieve a better balance between performance, power efficiency, and reliability across a wide range of workloads and operating conditions.

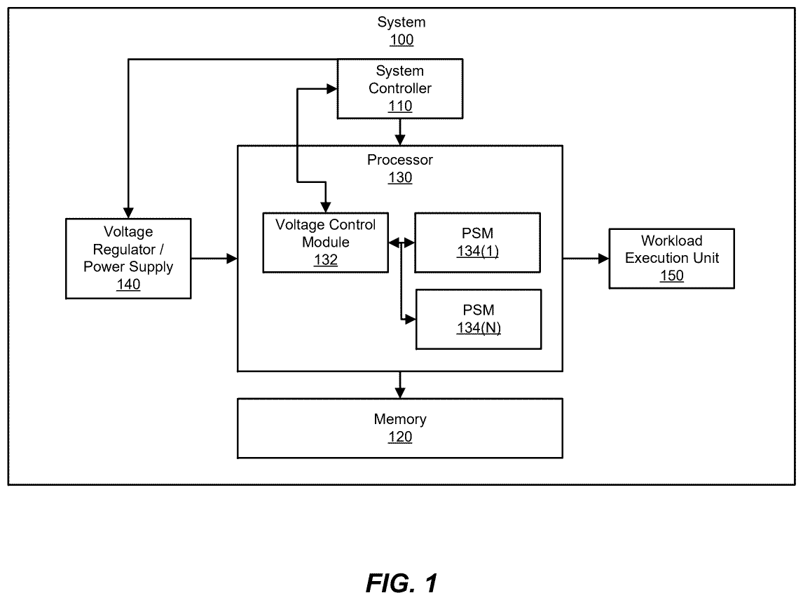

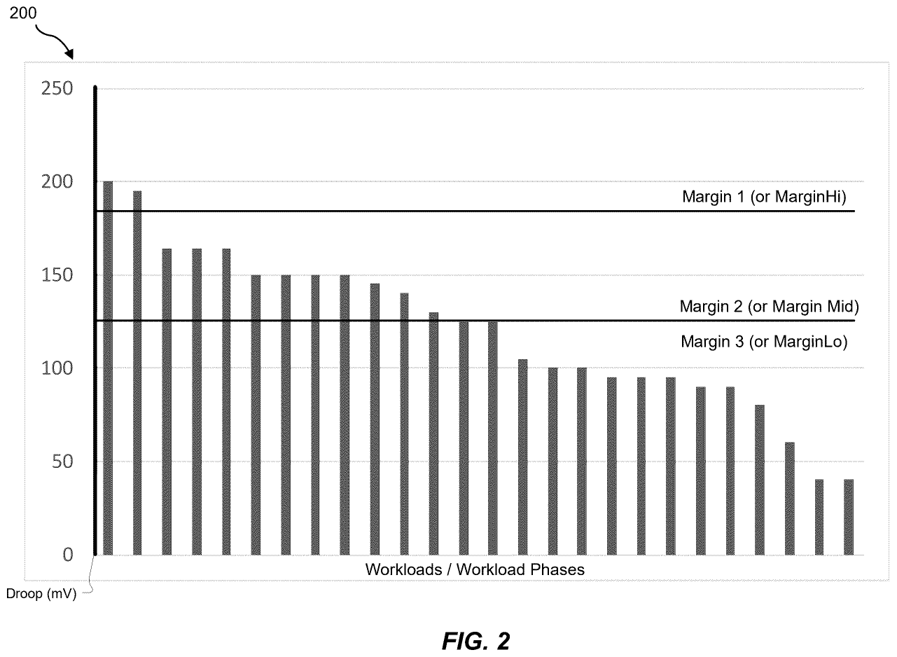

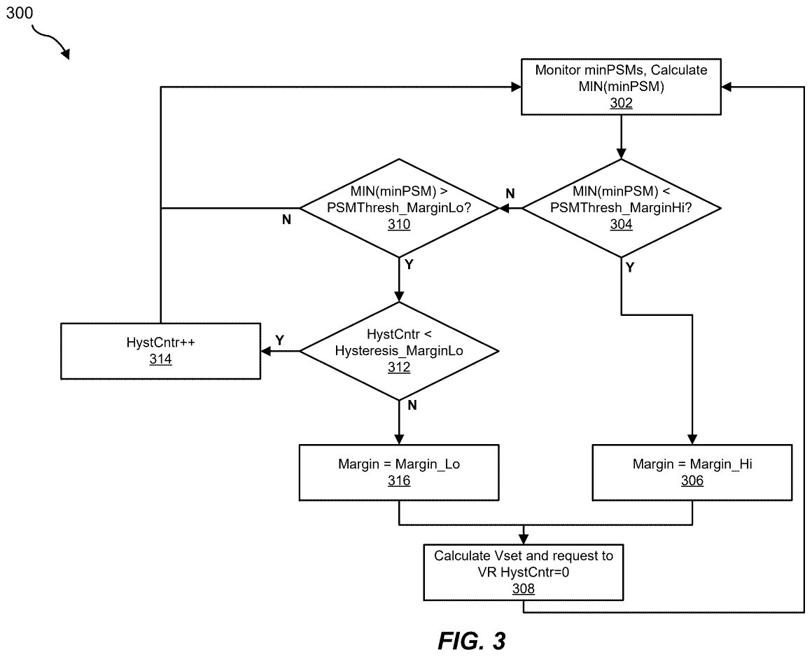

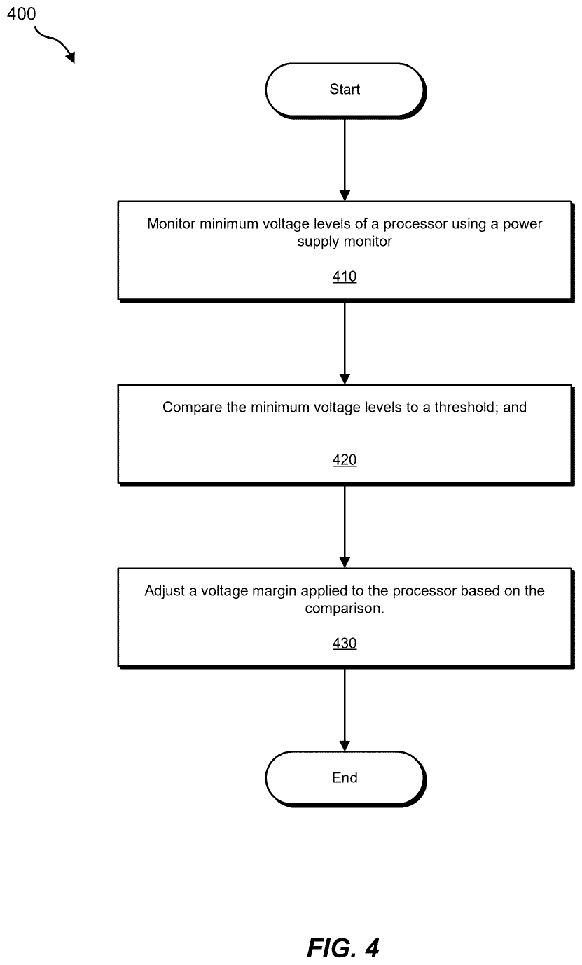

The following will provide, with reference to FIGS. 1-4, detailed descriptions of various implementations of systems and methods for dynamic voltage margin adjustment. FIG. 1 illustrates a block diagram of a computing system that may implement dynamic voltage margin adjustment. FIG. 2 illustrates a voltage graph depicting voltage droop levels, thresholds, and margins, which may be used to visualize voltage behavior in the dynamic voltage margin adjustment system. FIG. 3 presents a flowchart of a method for dynamic voltage margin adjustment, detailing the decision-making process involved in adjusting voltage margins. FIG. 4 illustrates another flowchart of a method for dynamic voltage margin adjustment, providing a simplified overview of the key steps involved in the process.

The present disclosure is generally directed to a device for dynamic voltage margin adjustment. Particularly, the device comprises a processor, a PSM configured to measure voltage levels of the processor, and a voltage control module. The voltage control module is configured to monitor minimum voltage levels reported by the PSM, compare the minimum voltage levels to a threshold, and adjust a voltage margin applied to the processor based on the comparing of the minimum voltage levels to the threshold.

In some embodiments, the voltage control module is further configured to maintain a first voltage margin when the minimum voltage levels are below a first threshold, switch to a second voltage margin when the minimum voltage levels are above a second threshold for a predetermined time period, wherein the second voltage margin is lower than the first voltage margin, and switch back to the first voltage margin when the minimum voltage levels drop below the first threshold.

In some embodiments, at least one of: the first threshold is different from the second threshold; or the first voltage margin is different from the second voltage margin.

In some embodiments, the PSM comprises multiple PSMs distributed across a die of the processor.

In some embodiments, the voltage control module is configured to monitor a minimum voltage level across all of the multiple PSMs.

In some embodiments, the voltage control module is further configured to apply different voltage margins for different types of workloads executed by the processor.

In some embodiments, the different types of workloads include at least one of: typical application workloads, worst-case profiled workloads, and worst-case pathological workloads.

In some embodiments, the voltage control module is further configured to maintain a first voltage margin when the minimum voltage levels are below a first threshold, switch to a second voltage margin when the minimum voltage levels are above a second threshold for a predetermined time period, wherein the second voltage margin is lower than the first voltage margin, switch to a third voltage margin when the minimum voltage levels are above a third threshold for a second predetermined time period, wherein the third voltage margin is lower than the second voltage margin, and switch back to a higher voltage margin when the minimum voltage levels drop below any of the thresholds.

The present disclosure is further directed to a system. Particularly, the system comprises a processor, a PSM configured to measure voltage levels of the processor, a voltage control module, a memory coupled to the processor, and a voltage regulator coupled to the processor and configured to supply power to the processor based on control signals from the voltage control module. The voltage control module is configured to monitor minimum voltage levels reported by the PSM, compare the minimum voltage levels to a threshold, and adjust a voltage margin applied to the processor based on the comparing of the minimum voltage levels to the threshold.

In some embodiments, the system further comprises a workload execution unit coupled to the processor and configured to execute various processing tasks.

In some embodiments, the voltage control module is further configured to maintain a first voltage margin when the minimum voltage levels are below the threshold, and switch to a second voltage margin when the minimum voltage levels are above the threshold for a predetermined time period, wherein the second voltage margin is lower than the first voltage margin.

In some embodiments, the voltage control module is further configured to switch back to the first voltage margin when the minimum voltage levels drop below the threshold.

In some embodiments, the PSM comprises multiple PSMs distributed across a die of the processor.

In some embodiments, the voltage control module is configured to monitor a minimum voltage level across all of the multiple PSMs.

In some embodiments, the voltage control module is further configured to apply different voltage margins for different types of workloads executed by the processor.

In some embodiments, the different types of workloads include at least one of: typical application workloads, worst-case profiled workloads, and worst-case pathological workloads.

In some embodiments, the voltage control module is further configured to maintain a first voltage margin when the minimum voltage levels are below a first threshold, switch to a second voltage margin when the minimum voltage levels are above a second threshold for a predetermined time period, wherein the second voltage margin is lower than the first voltage margin, switch to a third voltage margin when the minimum voltage levels are above a third threshold for a second predetermined time period, wherein the third voltage margin is lower than the second voltage margin, and switch back to a higher voltage margin when the minimum voltage levels drop below any of the thresholds.

In some embodiments, the voltage control module is further configured to incorporate machine learning techniques to refine voltage margin adjustment strategies based on historical data of voltage behavior and workload characteristics.

In some embodiments, the system further comprises user-configurable parameters that allow fine-tuning of voltage margin behavior based on specific application requirements or system configurations.

The present disclosure is also directed to a method for dynamic voltage margin adjustment. Particularly, the method comprises monitoring minimum voltage levels of a processor using a PSM, comparing the minimum voltage levels to a threshold, and adjusting a voltage margin applied to the processor based on the comparing of the minimum voltage levels to the threshold.

In some embodiments, the method further comprises maintaining a first voltage margin when the minimum voltage levels are below the threshold, and switching to a second voltage margin when the minimum voltage levels are above the threshold for a predetermined time period, wherein the second voltage margin is lower than the first voltage margin.

In some embodiments, the method further comprises switching back to the first voltage margin when the minimum voltage levels drop below the threshold.

FIG. 1 illustrates a block diagram of a computing system 100 for dynamic voltage margin adjustment. The computing system 100 may include a system controller 110, a memory 120, a processor 130, a voltage regulator 140, and a workload execution unit 150. The processor 130 may contain a voltage control module 132 and multiple PSMs, including a first PSM 134(1) through an nth PSM 134(N). In some aspects, the system controller 110 and voltage control module 132 may communicate bidirectionally, as indicated by a double-ended arrow between these components.

The processor 130 may contain a voltage control module 132 and multiple PSMs, including a first PSM 134(1) through an nth PSM 134(N). The PSMs 134(1)-134(N) may be configured to measure voltage levels of the processor 130. In some cases, the PSMs 134(1)-134(N) may be distributed across a die of the processor 130. As used herein, a “power supply monitor” may refer to a component or circuit configured to measure, detect, or sense voltage levels, current levels, or other electrical characteristics associated with power delivery to a processor or other integrated circuit. A PSM may include analog-to-digital converters, comparators, or other sensing circuitry to provide digital or analog representations of measured power supply parameters. In some examples, a power supply monitor may be configured to monitor voltage levels, and hence may be referred to as a voltage monitor.

The voltage control module 132 may be configured to monitor minimum voltage levels reported by the PSMs 134(1)-134(N). In some cases, the voltage control module 132 may monitor a minimum voltage level across all of the multiple PSMs 134(1)-134(N). The voltage control module 132 may be further configured to compare the minimum voltage levels to a threshold and adjust a voltage margin applied to the processor 130 based on the comparison. In some aspects, the voltage control module 132 may include circuitry and/or software components designed to analyze voltage data, make decisions based on predefined criteria, and control voltage settings. The voltage control module 132 may interface with other system components such as the voltage regulator 140 to implement voltage adjustments. In some implementations, the voltage control module 132 may be implemented as software stored on a computer-readable medium. When executed by a processor, this software may cause the processor to perform operations for dynamically adjusting voltage margins based on workload characteristics and historical voltage behavior.

As used herein, the term “workload” may refer to a set of computational tasks or processes executed by a processor or computing system. In the context of dynamic voltage margin adjustment, a workload may be characterized by its power consumption profile, voltage droop characteristics, and processing intensity. Different types of workloads may include: (1) typical application workloads: Common computational tasks that may represent average use cases and may not cause significant voltage fluctuations; (2) worst-case profiled workloads: High-intensity computational tasks that may be identified during system characterization as potentially causing substantial voltage droop, which may require higher voltage margins to maintain stability; and (3) worst-case pathological workloads: Extreme scenarios or newly discovered computational patterns that may cause severe voltage fluctuations, potentially requiring higher voltage margins to help maintain system reliability with very high probability. The nature and intensity of a workload may influence the voltage behavior of the processor, which may affect the dynamic voltage margin adjustment process.

As used herein, the term “margin” may refer to an additional amount of voltage applied above a minimum required operating voltage for a processor or integrated circuit. The margin may serve as a buffer to account for voltage fluctuations, potentially helping to maintain stable operation across various workloads and operating conditions with very high probability. In the context of dynamic voltage margin adjustment, the margin may be variable and adjusted based on real-time monitoring of voltage levels.

As used herein, “voltage margin” may refer to the difference between the actual supplied voltage and the minimum voltage required for stable processor operation. The voltage margin may be dynamically adjusted to potentially optimize performance and power efficiency based on workload characteristics and measured voltage levels.

As used herein, the term “dynamic voltage margin” may refer to a technique for adjusting the voltage margin applied to a processor in real-time based on monitored voltage levels and workload characteristics. This approach may allow for different voltage margins to be applied for various types of workloads, potentially improving performance for typical applications while maintaining stability for more demanding tasks.

As used herein, the term “threshold” may refer to a predetermined or dynamically determined value used as a reference point for comparison or decision-making within a system or process. In the context of voltage management, a threshold may represent a specific voltage level, percentage, or other quantifiable measure against which monitored voltage levels are compared. Thresholds may be used to trigger actions, such as adjusting voltage margins or switching between different operational modes. In some cases, multiple thresholds may be employed to create ranges or bands for more granular control. Thresholds may be fixed values set during system design or calibration, or they may be adaptive values that change based on operating conditions, historical data, or other factors.

The system controller 110 may connect to and manage the voltage regulator 140 and processor 130. The voltage regulator 140 may provide power to the processor 130 and receive control signals from the voltage control module 132. The workload execution unit 150 may be connected to the processor 130 and execute various processing tasks.

The memory 120 may be connected to the processor 130 and provide storage capabilities for the computing system 100. The voltage control module 132 may use the monitored voltage data to dynamically adjust voltage margins based on the workload being executed by the workload execution unit 150.

In some cases, the dynamic voltage margin adjustment capabilities of the computing system 100 may allow for optimized performance and power efficiency across various workloads and operating conditions.

FIG. 2 illustrates a voltage graph 200 depicting voltage droop levels, thresholds, and margins. The voltage graph 200 includes a Y-axis representing voltage droop in millivolts (mV). The graph may include two horizontal lines that may represent thresholds. These thresholds may be used for determining voltage margin adjustments.

In some aspects, the voltage graph 200 may include three zones marked as Margin1, Margin2, and Margin3 from top to bottom. Margin1 may be the highest margin level, while Margin3 may be the lowest margin level. The margin levels may be represented as voltage adders, typically much smaller than the absolute voltage levels.

The two horizontal lines may delineate different droop thresholds used for determining voltage margin adjustments. In some implementations, the uppermost line may correspond to a first threshold (Threshold1), and the lowermost line to a second threshold (Threshold2). These thresholds may be represented in millivolts.

The voltage control module may compare the droop levels to the upper threshold line and/or the lower threshold line to determine when to adjust the voltage margin. In some implementations, when the droop levels remain below the upper threshold line for a predetermined period, the voltage control module may switch from the first margin level to the second margin level. The second margin level may be lower than the first margin level, potentially allowing for improved performance or power efficiency when the processor is experiencing less severe voltage droops.

In some cases, if the droop levels rise above the upper threshold line, the voltage control module may switch back to the first margin level. This dynamic adjustment between the first margin level and the second margin level based on the behavior of the droop levels relative to the upper threshold line and lower threshold line may form the basis of the dynamic voltage margin adjustment process.

In some implementations, the voltage control module may transition from the second margin level (Margin2) to the third margin level (Margin3). This third margin level may be lower than both the first and second margin levels, potentially allowing for further optimization of performance or power efficiency when the processor consistently experiences minimal voltage droops. The voltage control module may continuously monitor the droop levels and dynamically adjust between a plurality of margin levels based on the observed voltage behavior, providing a more granular approach to voltage margin management. This multi-level margin adjustment may enable the system to adapt more precisely to varying workload characteristics and operating conditions.

FIG. 3 illustrates a method 300 for dynamic voltage margin adjustment. The method 300 may be implemented by a voltage control module, such as the voltage control module 132 shown in FIG. 1.

The method 300 begins with a step 302, where minimum PSM values are monitored. In some cases, the voltage control module may monitor minimum voltage levels using multiple PSMs distributed across a die of the processor. The voltage control module may calculate the minimum value across all PSMs on the die or voltage domain.

After monitoring the minimum PSM values, the method 300 proceeds to a decision 304. At the decision 304, the voltage control module may compare the minimum PSM value to a high margin threshold. If the minimum PSM value is less than the high margin threshold, the method 300 moves to a step 306. At the step 306, the voltage margin is set to a high margin value (Margin_Hi). This high margin value may correspond to a first voltage margin that the voltage control module maintains when the minimum voltage levels are below the threshold.

If the minimum PSM value is not less than the high margin threshold at the decision 304, the method 300 proceeds to a decision 310. At the decision 310, the voltage control module may compare the minimum PSM value to a low margin threshold. If the minimum PSM value is not greater than the low margin threshold, the method 300 returns to the step 302 to continue monitoring the minimum PSM values.

If the minimum PSM value is greater than the low margin threshold at the decision 310, the method 300 moves to a decision 312. At the decision 312, the voltage control module may evaluate whether a hysteresis counter is less than a low margin hysteresis value. This hysteresis mechanism allows the voltage control module to monitor minimum PSM values for a configurable amount of time before switching to a lower margin.

If the hysteresis counter is less than the low margin hysteresis value at the decision 312, the method 300 proceeds to a step 314. At the step 314, the hysteresis counter is incremented. The method 300 then returns to the step 302 to continue monitoring the minimum PSM values.

If the hysteresis counter is not less than the low margin hysteresis value at the decision 312, the method 300 moves to a step 316. At the step 316, the voltage margin is set to a low margin value (Margin_Lo). This low margin value may correspond to a second voltage margin that the voltage control module switches to when the minimum voltage levels are above the threshold for a predetermined time period. The second voltage margin may be lower than the first voltage margin.

After either the step 306 or the step 316, the method 300 proceeds to a step 308. At the step 308, the voltage control module may calculate a voltage set point based on the selected margin (either Margin_Hi or Margin_Lo) and request this voltage from a voltage regulator. The voltage control module may also reset the hysteresis counter to zero at this step.

After the step 308, the method 300 returns to the step 302 to continue monitoring the minimum PSM values. This loop allows the voltage control module to continuously adjust the voltage margin based on the monitored voltage levels.

In some cases, if the minimum PSM value drops below the high margin threshold at any point during the method 300, the voltage control module may immediately switch back to the first voltage margin (Margin_Hi). This immediate switch may occur regardless of the current state of the hysteresis counter, ensuring that sufficient voltage margin is applied when needed.

FIG. 4 is a flow diagram of an example method 400 for dynamic voltage margin adjustment. The steps shown in FIG. 4 can be performed by any suitable computing module, computer-executable code, and/or computing system, including computing system 100 in FIG. 1 and/or variations or combinations of one or more of the same. In one example, each of the steps shown in FIG. 4 can represent an algorithm whose structure includes and/or is represented by multiple sub-steps, examples of which are provided herein. The method 400 may provide a simplified approach to implementing dynamic voltage margin control based on monitored voltage levels.

The method 400 includes a step 410 of monitoring minimum voltage levels of a processor using a PSM. In some cases, the PSM may include multiple PSMs distributed across a die of the processor. The minimum voltage levels may be determined by selecting the lowest voltage level reported across all of the multiple PSMs.

Following the monitoring step, the method 400 proceeds to a step 420 of comparing the minimum voltage levels to a threshold. This comparison may involve evaluating whether the monitored minimum voltage levels are above or below a predetermined threshold value.

Based on the comparison performed in step 420, the method 400 moves to a step 430 of adjusting a voltage margin applied to the processor. The adjustment of the voltage margin may involve increasing or decreasing the margin depending on the relationship between the monitored minimum voltage levels and the threshold.

In some cases, the method 400 may be implemented using instructions stored on a non-transitory computer-readable medium. These instructions, when executed by a processor, may cause the processor to perform operations corresponding to the steps of the method 400. The operations may include receiving minimum voltage level data from a PSM or from multiple PSMs distributed across a die of the processor.

The method 400 provides a streamlined approach to dynamic voltage margin adjustment, capturing the essential steps of monitoring, comparing, and adjusting. This method may be used in conjunction with or as an alternative to the more detailed methods described earlier, depending on the specific requirements of the system and the desired level of control granularity.

In some cases, the dynamic voltage margin adjustment system may be configured to apply different voltage margins for different types of workloads executed by a processor. The system may categorize workloads into various types, such as typical application workloads, worst-case profiled workloads, and worst-case pathological workloads. By distinguishing between these workload types, the system may optimize performance and power efficiency for each scenario.

For typical application workloads, which may include common computational tasks that represent average use cases and may not cause significant voltage fluctuations, the system may apply a lower voltage margin. This approach may allow for improved performance or power efficiency in common usage scenarios. Worst-case profiled workloads, which may be high-intensity computational tasks identified during system characterization as potentially causing substantial voltage droop, may receive a higher voltage margin to help maintain stability with very high probability. In some cases, the system may apply an even higher voltage margin for worst-case pathological workloads, which may represent extreme scenarios or newly discovered computational patterns that may cause severe voltage fluctuations, potentially requiring higher voltage margins to help maintain system reliability with very high probability.

The voltage control module may be designed to support more than two levels of voltage margin. This multi-level approach may allow for finer granularity in adjusting the voltage margin based on the observed voltage behavior. For example, the system may implement low, medium, and high voltage margins, each corresponding to different ranges of minimum voltage levels observed by the PSMs.

In some implementations, the voltage control module may be capable of applying extra margin for pathological cases that may not be covered by the default margin. This feature may be particularly useful for addressing late discoveries during program execution or accommodating workloads that exhibit unexpected voltage characteristics. The ability to dynamically increase the voltage margin for these extreme cases may enhance system reliability without compromising performance for more typical workloads.

The dynamic voltage margin adjustment system may be extended to handle multiple voltage domains within a processor or across multiple processors in a system. Each voltage domain may have its own set of PSMs and voltage control parameters, allowing for independent optimization of voltage margins based on the specific characteristics and workloads of each domain.

In some cases, the dynamic voltage margin adjustment system may be integrated with other power management techniques. For example, the system may work in conjunction with dynamic voltage and frequency scaling (DVFS) algorithms to provide a comprehensive approach to power and performance optimization. The voltage margin adjustments may be coordinated with frequency changes to ensure optimal operation across various workload scenarios and power states.

The system may also incorporate machine learning techniques to improve its decision-making process over time. By analyzing historical data on voltage behavior and workload characteristics, the voltage control module may refine its voltage margin adjustment strategies to better predict and respond to different types of workloads.

In some implementations, the dynamic voltage margin adjustment system may include user-configurable parameters. This feature may allow system administrators or advanced users to fine-tune the voltage margin behavior based on specific application requirements or system configurations. Configurable parameters may include, without limitation, threshold values, hysteresis timers, the number of voltage margin levels, and/or the voltage margin levels themselves.

The system may also provide mechanisms for logging and reporting voltage margin adjustments and related events. This information may be valuable for system debugging, performance analysis, and long-term optimization of the voltage margin adjustment strategies.

As explained above in connection with FIGS. 1-4, a processor may implement dynamic voltage margin (DVM) adjustment to optimize performance and power efficiency across different workloads. For example, the processor may monitor minimum voltage levels using multiple PSMs (PSMs) distributed across the die. Upon detecting that the minimum PSM values remain above a certain threshold for a sustained period, the processor may switch from a higher voltage margin (Margin_Hi) to a lower voltage margin (Margin_Lo).

By dynamically adjusting the voltage margin based on workload characteristics, the processor may be able to improve performance for typical applications that do not require conservative voltage settings, while still maintaining stability for more demanding workloads. Accordingly, the DVM system may potentially reduce power consumption and improve energy efficiency for less intensive tasks.

Moreover, by dynamically adjusting the voltage margin when minimum PSM values drop below a threshold, the system may apply appropriate margins for different workload phases with very high probability. This dynamic approach may allow the system to adapt to varying operating conditions, including worst-case pathological workloads, while potentially optimizing performance and power efficiency for typical applications.

The DVM approach allows for applying different amounts of voltage margin depending on the nature of the workload, potentially avoiding performance churn that may occur with fixed margin approaches when new virus workloads are discovered. This dynamic adjustment between Margin_Hi and Margin_Lo based on monitored PSM values may facilitate better utilization of processor capabilities and enhanced overall system performance compared to traditional fixed voltage margin approaches.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

In some examples, all or a portion of computing system 100 in FIG. 1 can represent portions of a cloud-computing or network-based environment. Cloud-computing environments can provide various services and applications via the Internet. These cloud-based services (e.g., software as a service, platform as a service, infrastructure as a service, etc.) can be accessible through a web browser or other remote interface. Various functions described herein can be provided through a remote desktop environment or any other cloud-based computing environment.

According to various implementations, all or a portion of computing system 100 in FIG. 1 can be implemented within a virtual environment. For example, the modules and/or data described herein can reside and/or execute within a virtual machine. As used herein, the term “virtual machine” can generally refer to any operating system environment that is abstracted from computing hardware by a virtual machine manager (e.g., a hypervisor).

In some examples, all or a portion of computing system 100 in FIG. 1 can represent portions of a mobile computing environment. Mobile computing environments can be implemented by a wide range of mobile computing devices, including mobile phones, tablet computers, e-book readers, personal digital assistants, wearable computing devices (e.g., computing devices with a head-mounted display, smartwatches, etc.), variations or combinations of one or more of the same, or any other suitable mobile computing devices. In some examples, mobile computing environments can have one or more distinct features, including, for example, reliance on battery power, presenting only one foreground application at any given time, remote management features, touchscreen features, location and movement data (e.g., provided by Global Positioning Systems, gyroscopes, accelerometers, etc.), restricted platforms that restrict modifications to system-level configurations and/or that limit the ability of third-party software to inspect the behavior of other applications, controls to restrict the installation of applications (e.g., to only originate from approved application stores), etc. Various functions described herein can be provided for a mobile computing environment and/or can interact with a mobile computing environment.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

While various implementations have been described and/or illustrated herein in the context of fully functional computing systems, one or more of these example implementations can be distributed as a program product in a variety of forms, regardless of the particular type of computer-readable media used to actually carry out the distribution. The implementations disclosed herein can also be implemented using modules that perform certain tasks. These modules can include script, batch, or other executable files that can be stored on a computer-readable storage medium or in a computing system. In some implementations, these modules can configure a computing system to perform one or more of the example implementations disclosed herein.

The preceding description has been provided to enable others skilled in the art to best utilize various aspects of the example implementations disclosed herein. This example description is not intended to be exhaustive or to be limited to any precise form disclosed. Many modifications and variations are possible without departing from the spirit and scope of the present disclosure. The implementations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A device for dynamic voltage margin adjustment, comprising:
a processor;
a power supply monitor (PSM) configured to measure voltage levels of the processor; and
a voltage control module configured to:
monitor minimum voltage levels reported by the PSM;
compare the minimum voltage levels to a threshold; and
adjust a voltage margin applied to the processor based on the comparing of the minimum voltage levels to the threshold.

2. The device of claim 1, wherein the voltage control module is further configured to:
maintain a first voltage margin when the minimum voltage levels are below a first threshold;
switch to a second voltage margin when the minimum voltage levels are above a second threshold for a predetermined time period, wherein the second voltage margin is lower than the first voltage margin; and
switch back to the first voltage margin when the minimum voltage levels drop below the first threshold.

3. The device of claim 2, wherein at least one of:
the first threshold is different from the second threshold; or the first voltage margin is different from the second voltage margin.

4. The device of claim 1, wherein the PSM comprises multiple PSMs distributed across a die of the processor.

5. The device of claim 4, wherein the voltage control module is configured to monitor a minimum voltage level across all of the multiple PSMs.

6. The device of claim 1, wherein the voltage control module is further configured to apply different voltage margins for different types of workloads executed by the processor.

7. The device of claim 6, wherein the different types of workloads include at least one of: typical application workloads, worst-case profiled workloads, and worst-case pathological workloads.

8. The device of claim 6, wherein the voltage control module is further configured to:
maintain a first voltage margin when the minimum voltage levels are below a first threshold;
switch to a second voltage margin when the minimum voltage levels are above a second threshold for a predetermined time period, wherein the second voltage margin is lower than the first voltage margin;
switch to a third voltage margin when the minimum voltage levels are above a third threshold for a second predetermined time period, wherein the third voltage margin is lower than the second voltage margin; and
switch back to a higher voltage margin when the minimum voltage levels drop below any of the thresholds.

9. A system comprising:
a processor;
a power supply monitor (PSM) configured to measure voltage levels of the processor;
a voltage control module configured to:
monitor minimum voltage levels reported by the PSM;
compare the minimum voltage levels to a threshold; and
adjust a voltage margin applied to the processor based on the comparing of the minimum voltage levels to the threshold;
a memory coupled to the processor; and
a voltage regulator coupled to the processor and configured to supply power to the processor based on control signals from the voltage control module.

10. The system of claim 9, further comprising a workload execution unit coupled to the processor and configured to execute various processing tasks.

11. The system of claim 9, wherein the voltage control module is further configured to:
maintain a first voltage margin when the minimum voltage levels are below the threshold; and
switch to a second voltage margin when the minimum voltage levels are above the threshold for a predetermined time period, wherein the second voltage margin is lower than the first voltage margin.

12. The system of claim 11, wherein the voltage control module is further configured to switch back to the first voltage margin when the minimum voltage levels drop below the threshold.

13. The system of claim 9, wherein the PSM comprises multiple PSMs distributed across a die of the processor.

14. The system of claim 13, wherein the voltage control module is configured to monitor a minimum voltage level across all of the multiple PSMs.

15. The system of claim 9, wherein the voltage control module is further configured to apply different voltage margins for different types of workloads executed by the processor.

16. The system of claim 9, wherein the voltage control module is further configured to incorporate machine learning techniques to refine voltage margin adjustment strategies based on historical data of voltage behavior and workload characteristics.

17. The system of claim 9, further comprising user-configurable parameters that allow fine-tuning of voltage margin behavior based on specific application requirements or system configurations.

18. A method for dynamic voltage margin adjustment, comprising:
monitoring minimum voltage levels of a processor using a power supply monitor (PSM);
comparing the minimum voltage levels to a threshold; and
adjusting a voltage margin applied to the processor based on the comparing of the minimum voltage levels to the threshold.

19. The method of claim 18, further comprising:
maintaining a first voltage margin when the minimum voltage levels are below the threshold; and
switching to a second voltage margin when the minimum voltage levels are above the threshold for a predetermined time period, wherein the second voltage margin is lower than the first voltage margin.

20. The method of claim 19, further comprising switching back to the first voltage margin when the minimum voltage levels drop below the threshold.
